(19) United States
(12) Patent Application Publication
(10) Pub. No.: US 2007/0275854 A1
(43) Pub. Date: Nov. 29, 2007

(54) Agrochemical Composition Containing Phosphoric Acid Ester

(76) Inventors: Joachim Hess, Hofheim (DE); Ralf Zerrer, Karlstein (DE); Christian Sowa, Neustadt/Weinstrasse (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/664,329

(22) PCT Filed: Sep. 22, 2005
(86) PCT No.: PCT/EP05/10255

§ 371 Date: Jul. 24, 2007

(30) Foreign Application Priority Data
Sep. 29, 2004 (DE) 10 2004 047 092.8

(51) Int. Cl. A01N 57/12; A01N 43/40; A01N 43/42; A01N 43/54; A01N 43/58; A01P 11/00; A01P 15/00; A01P 5/00; A01P 7/04; A01P 9/00; A01P 7/02; A01P 3/00; A01P 13/00; A01N 43/60; A01N 43/70; A01N 43/84; A01N 43/88

(52) U.S. Cl. 504/128; 514/129; 514/222.8; 514/230.5; 514/245; 514/247; 514/249; 514/250; 514/266.31; 514/272; 514/312; 514/314; 514/341

(57) ABSTRACT

Agrochemical compositions comprising a) one or more substances selected from pesticides and phytohormones and b) one or more substances selected from alkyl phosphoric esters and alkylaryl phosphoric esters, wherein the compounds of component b) comprise one or more branched alkyl groups, are described.

The present invention relates to agrochemical compositions comprising one or more pesticidal active substances and/or one or more phytohormones, and one or more substances selected from alkyl phosphoric esters having branched alkyl groups and alkylaryl phosphoric esters having branched alkyl groups.

The phosphoric esters increase the biological activity of the pesticides (herbicides, insecticides, fungicides, acaricides, bactericides, molluscides, nematicides and rodenticides) and of the phytohormones, improve the solubility in both aqueous and organic medium, and the compatibility of individual ingredients of the pesticidal compositions.

Most pesticides are herbicides, followed by insecticides and fungicides. The most important herbicides are chemical substances which act on the transport system of plants, for example by inhibiting photosynthesis, fatty acid biosynthesis or amino acid biosynthesis, and lead to inhibition of germination and growth or to death of the plant.

Phytohormones control physiological reactions such as growth, flowering rhythm, cell division and seed ripening.

The biological activity of a pesticide or phytohormone can be determined on the basis of the plant growth or the damage to the plants through the action of the active substance on the leaf as a function of the exposure time and the effective concentration.

For optimal display of the pesticidal effect, the pesticide must wet the chlorophyll and remain there for a sufficiently long time, or the active substance must penetrate through the leaf surface. To this end, as described in a large number of patents, adjuvants which improve the wettability, the solubility, the emulsifiability or the adsorption behavior of the active substance are added to the pesticide formulations.

Agrochemical compositions such as, for example, crop protection formulations must satisfy stringent requirements in relation to the chemical and physical stability under extreme temperature conditions with long storage times. In addition, the compositions are exposed to high shear forces during application to fields.

It has now surprisingly been found that agrochemical compositions such as, for example, crop protection formulations comprising
a) one or more substances selected from pesticides and phytohormones and
b) one or more substances selected from alkyl phosphoric esters and alkylaryl phosphoric esters,
   wherein the compounds of component b) comprise one or more branched alkyl groups,
   show a significant increase in the activity of the pesticides, improve the compatibility of ingredients (pesticides, adjuvants, dispersants, electrolytes etc.) having very different physicochemical properties, increase the solubility of the pesticides and, where appropriate, further ingredients both in the aqueous and in the organic medium, and are stable even when highly stressed. In addition, branched alkyl phosphoric esters and alkylaryl phosphoric esters having branched alkyl groups are good dispersants or emulsifiers and can thus be employed outstandingly in dispersions, especially suspensions and emulsions.

The present invention therefore relates to compositions comprising
a) one or more substances selected from pesticides and phytohormones and
b) one or more substances selected from alkyl phosphoric esters and alkylaryl phosphoric esters,
   wherein the compounds of component b) comprise one or more branched alkyl groups.

In a preferred embodiment of the invention, all the alkyl groups present in the compounds of component b) are branched.

In a further preferred embodiment of the invention, the number of carbon atoms in all the alkyl groups of the compounds of component b) totals from 6 to 36, preferably from 6 to 30 and particularly preferably from 8 to 22.

In a further preferred embodiment of the invention, the one or more substances of component b) are selected from compounds of the formula (I) 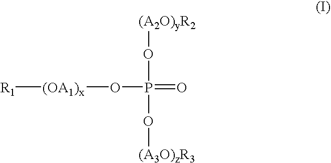
in which
R₁ is a branched, saturated or unsaturated alkyl or alkenyl radical having 6 to 30, preferably having 8 to 22 and particularly preferably having 12 to 18 carbon atoms, or an aryl group, in particular a phenyl group, which is substituted by 1 to 3 branched alkyl groups, each of which comprise independently of one another 3 to 18 and preferably 4 to 12 carbon atoms,
R₂ and R₃ are each independently of one another hydrogen, alkali metal, alkaline earth metal, substituted or unsubstituted ammonium or organic basic groups or R₁,
A₁, A₂ and A₃ are each independently of one another an alkylene group having 2 to 4 carbon atoms, and
x, y and z are each independently of one another a number from 0 to 30, preferably from 1 to 20, particularly preferably from 4 to 10 and especially preferably from 6 to 8,
   and which comprise one or more branched alkyl groups.

A₁, A₂ and A₃ in the compounds of the formula (I) are each independently of one another in particular ethylene, propylene or butylene.

In a further preferred embodiment of the invention, the one or more substances of component b) is selected from isotridecyl phosphoric esters optionally comprising ethylene oxide units, and their salts. Preferred compounds among these are those comprising 0 to 30, preferably 1 to 20 and particularly preferably 2 to 10 ethylene oxide units. Particular preference is given to mixtures of isotridecyl phosphoric esters in which the proportion of monoester is from 40 to 60% by weight and the proportion of diester is from 40 to 60% by weight.

In a further preferred embodiment of the invention, the one or more substances of component b) is selected from tri-sec-butylphenol phosphoric esters optionally comprising ethylene units, and their salts. Preferred compounds among these are those comprising 4 to 8 ethylene oxide units. Particular preference is given to mixtures of tri-sec-butylphenol phosphoric esters in which the proportion of monoester is from 40 to 60% by weight and the proportion of diester is from 40 to 60% by weight.

The substances of component b) having branched alkyl groups which are used in the compositions of the invention have the advantage compared with analogous compounds which, however, comprise no branched alkyl groups or comprise exclusively linear alkyl groups that the increase in activity is better.

The substances of component b) which are used in the compositions of the invention are prepared in a known manner by reacting tetraphosphorus decaoxide or orthophosphoric acid and fatty alcohols or alkoxylated fatty alcohols or the corresponding aromatic alcohols to form mono- and diesters with small proportions of triesters and, where appropriate, subsequent neutralization with suitable basic compounds, for example with alkali metal hydroxides, especially with NaOH and KOH, preferably with KOH, but also with basic amino acids, for example arginine, ornithine, lysine, oxylsine and alkanolamines, for example triethanolamine, diethanolamine, monoethanolamine or with substituted or unsubstituted ammonium compounds.

In a further preferred embodiment of the invention, the one or more substances of component a) are selected from pesticides, preferably from the group consisting of herbicides, insecticides, fungicides, acaricides, bactericides, molluscides, nematicides and rodenticides. Among these substances in turn herbicides are preferred.

Suitable herbicides are, without restricting the invention thereto, acetochlor, acifluorfen, aclonifen, acrolein, alachlor, ametryn, amitrol, asulam, atrazine, benazolin, bensulfuron-methyl, bentazone, benzofenap, bialaphos, bifenox, bilanafos, bromacil, bromobutide, bromofenoxim, bromoxynil, butachlor, butafenacil, chlormethoxyfen, chloramben, chloracetic acid, chlorbromuron, chlorimuron-ethyl, chlorotoluron, chlornitrofen, chlorotoluron, chlorthal-dimethyl, clodinafop, clodinafop propargyl, clopyralid, clomeprop, cyanazine, 2,4-D, 2,4-DB, diamuron, dalapon, desmedipham, desmetryn, dicamba, dichlorbenil, dichlorprop, diclofop, difenzoquat, diflufenican, dimefuron, dimethachlor, dimethametryn, dimethenamid, dinitramine, diquat, diuron, endothall, ethametsulfuron-methyl, fenac, fenclorim, fenoxaprop, fenoxaprop-ethyl, flamprop, fenoxaprop-methyl, flazasulfuron, fluazifop, fluazifop-p-butyl, flumetsulam, flumiclorac, flumiclorac-phenyl, fluoroglycofen, flumetsulam, flumeturon, flumioxazin, flupoxam, flupropanate, fluridon, flurtamon, fomesafen, fosamine, glufosinate, glyphosate, haloxyfop, imazapic, imazameth, imazamethabenz, imazamox, imazapic, imazapyr, imazaquin, imazethapyr, imazethapyr-ammonium, ioxynil, isoproturon, isoxaben, isoxapyrifop, lactofen, lenacil, linuron, MCPA, MCPB, mecoprop, mefenacet, mesotrion, metazachlor, methabenzthiazuron, methylarsonic acid, metachlor, metobenzuron, naproanilide, naptalam, neburon, nonanoic acid, norflurazon, oryzalin, oxadiazon, oxyfluorfen, paraquat, phenmedipham, picloram, pretilachlor, prodiamine, prometon, prometryn, propachlor, propazine, propisochlor, propyzamide, pyrazolynate, pyrazosulfuron-ethyl, pyributicarb, pyridate, quinclorac, quizalofop, quizalofop-ethyl, rimsulfuron, siduron, simazine, simetryn, sulfamic acid, 2,3,6-TBA, TCA, terbumeton, terbuthylazine, terbutyrin, trichloroacetic acid, triclopyr, trietazine, thenylchlor, thiazopyr, trialkoxydim, trietazine and their salts.

In a particularly preferred embodiment of the invention, the one or more substances of component a) are selected from clodinafop propargyl and imazethapyr-ammonium.

The phosphoric esters of component b) of the compositions of the invention are suitable for example as adjuvant in crop protection formulations, both in solid form and in gel- or paste-like form and preferably in sprayable liquid form.

The compositions of the invention can be produced in solid form as powers, pellets, tablets or granules which are dissolved in water before use. Solid preparations comprise the one or more substances of component a) preferably in amounts of from 20 to 80, particularly preferably from 50 to 75 and especially preferably from 60 to 70% by weight and the one or more substances of component b) preferably in amounts of from 5 to 60 and particularly preferably from 10 to 30% by weight.

Concentrate formulations which are diluted before use comprise the one or more substances of component a) preferably in amounts of from 5 to 50 and particularly preferably from 20 to 40% by weight and the one or more substances of component b), preferably in amounts of from 5 to 70% by weight.

The compositions of the invention can be applied by conventional methods. Aqueous concentrates and solid formulations are diluted with the appropriate amount of water before application.

The amounts of pesticide and/or phytohormone applied per hectare are in the range from 0.1 to 5 kg, preferably 0.3 to 2.5 kg. The amount of substances of component b) is in the range from 0.10 to 2.1 kg/ha. The volume of the formulation prepared for spraying is in the range from 50 to 1000 l/ha.

The compositions of the invention may comprise surfactants, thickeners, antigelling agents, antifreezes, solvents, dispersants, emulsifiers, preservatives, further adjuvants, binders, antifoams, diluents, disintegrants and wetting agents.

In a further preferred embodiment of the invention, the compositions of the invention comprise anionic surfactants. Preferred anionic surfactants are straight-chain and branched alkyl sulfates, alkylsulfonates, alkylcarboxylates, alkyl phosphates, alkyl sulfosuccinates and alkyl taurates, alkyl ester sulfonates, alkylarylsulfonates and alkylether sulfates.

Alkyl sulfates are water-soluble salts or acids of the formula ROSO₃M in which R is preferably a C₁₀-C₂₄ hydrocarbon radical, particularly preferably an alkyl or hydroxyalkyl radical having 10 to 20 C atoms and especially preferably a C₁₂-C₁₈-alkyl or hydroxyalkyl radical. M is hydrogen or a cation, preferably an alkali metal cation (e.g. sodium, potassium, lithium) or ammonium or substituted ammonium, e.g. a methyl-, dimethyl- and trimethylammonium cation or a quaternary ammonium cation such as tetramethylammonium and dimethylpiperidinium cation and quarternary ammonium cations derived from alkylamines such as ethylamine, diethylamine, triethylamine and mixtures thereof.

The alkyl ether sulfates are water-soluble salts or acids of the formula RO(A)ₘSO₃M, in which R is preferably an unsubstituted C₁₀-C₂₄-alkyl or hydroxyalkyl radical, particularly preferably a C₁₂-C₂₀-alkyl or hydroxyalkyl radical and especially preferably a C₁₂-C₁₈-alkyl or hydroxyalkyl radical. A is an ethoxy or propoxy unit, m is a number greater than 0, typically between about 0.5 and about 6, particularly preferably between about 0.5 and about 3 and M is a hydrogen atom or a cation, preferably a metal cation (e.g. sodium, potassium, lithium, calcium, magnesium etc.), ammonium or a substituted ammonium cation. Examples of substituted ammonium cations are methyl-, dimethyl-, trimethylammonium and quaternary ammonium cations such as tetramethylammonium and dimethylpiperidinium cations, and those derived from alkylamines such as ethylamine, diethylamine, triethylamine or mixtures thereof. Examples which may be mentioned are C₁₂-C₁₈-alkyl polyethoxylate (1.0) sulfate, C₁₂-C₁₈-alkyl polyethoxylate (2.25) sulfate, C₁₂-C₁₈-alkyl polyethoxylate (3.0) sulfate, C₁₂-C₁₈-alkyl polyethoxylate (4.0) sulfate, where the cation is sodium or potassium.

Likewise suitable are alkylsulfonates having straight-chain or branched C₆-C₂₂-alkyl chains, for example primary paraffin sulfonates, secondary paraffin sulfonates, alkylarylsulfonates, for example linear alkylbenzenesulfonates having C₅-C₂₀-alkyl chains, alkylnaphthalenesulfonates, condensation products of naphthalenesulfonate and formaldehyde, lignosulfonate, alkyl ester sulfonates, i.e. sulfonated linear esters of C₈-C₂₀-carboxylic acids (i.e. fatty acids), C₈-C₂₄ olefinsulfonates, sulfonated polycarboxylic acids prepared by sulfonation of the pyrolysis products of alkaline earth metal citrates.

Further suitable anionic surfactants are selected from alkyl glycerol sulfates, fatty acyl glycerol sulfates, oleyl glycerol sulfates, alkylphenol ether sulfates, alkyl phosphates, alkyl ether phosphates, isethionates such as acyl isethionates, N-acyltaurides, alkyl succinamates, sulfosuccinates, monoesters of sulfosuccinates (especially saturated and unsaturated C₁₂-C₁₈ monoesters) and diesters of sulfosuccinates (especially saturated and unsaturated C₁₂-C₁₈ diesters), acylsarcosinates, sulfates of alkyl polysaccharides such as sulfates of alkyl polyglycosides, branched primary alkyl sulfates and alkyl polyethoxycarboxylates such as those of the formula RO(CH₂CH₂O)ₖCH₂COO⁻M⁺ in which R is a C₈-C₂₂-alkyl group, k is a number from 0 to 10 and M is a soluble salt-forming cation.

In a further preferred embodiment, the ratio by weight of the one or more substances of component b) to the one or more anionic surfactants is from 95:5 to 5:95, preferably from 80:20 to 20:80, particularly preferably from 80:20 to 70:30 or from 20:80 to 30:70.

In a further preferred embodiment, the compositions of the invention comprise as further component one or more nonionic surfactants, amphoteric surfactants and/or cationic surfactants. Preferred among these are those compositions of the invention which comprise as further component one or more nonionic surfactants and/or one or more amphoteric surfactants.

Suitable and preferred nonionic surfactants are fatty alcohol ethoxylates (alkylpolyethylene glycols), alkylphenol polyethylene glycols, alkyl mercaptan polyethylene glycols, fatty amine ethoxylates (alkylaminopolyethylene glycols), fatty acid ethoxylates (acylpolyethylene glycols), polypropylene glycol ethoxylates (e.g. Pluronics®), fatty acid alkylolamides (fatty acid amide polyethylene glycols), N-alkyl- and N-alkoxypolyhydroxy fatty acid amides, alkyl polysaccharides, sucrose esters, sorbitol esters and polyglycol ethers.

Suitable and preferred amphoteric surfactants are amphoacetates, particularly preferably monocarboxylates and dicarboxylates such as cocoamphocarboxypropionate, cocoamidocarboxypropionic acid, cocoamphocarboxylglycinate (or else referred to as cocoamphodiacetate) and cocoamphoacetate.

Cationic surfactants which can be employed are di-(C₁₀-C₂₄)-alkyldimethylammonium chloride or bromide, preferably di-(C₁₂-C₁₈)-alkyldimethylammonium chloride or bromide; (C₁₀-C₂₄)-alkyldimethylethylammonium chloride or bromide; (C₁₀-C₂₄)-alkyltrimethylammonium chloride or bromide, preferably cetyltrimethylammonium chloride or bromide and (C₂₀-C₂₂)-alkyltrimethylammonium chloride or bromide; (C₁₀-C₂₄)-alkyldimethylbenzylammonium chloride or bromide, preferably (C₁₂-C₁₈)-alkyldimethylbenzylammonium chloride; N—(C₁₀-C₁₈)-alkylpyridinium chloride or bromide, preferably N—(C₁₂-C₁₆)-alkylpyridinium chloride or bromide; N—(C₁₀-C₁₈)-alkylisoquinolinium chloride, bromide or monoalkyl sulfate; N—(C₁₂-C₁₈)-alkylpolyoylaminoformylmethylpyridinium chloride; N—(C₁₂-C₁₈)-alkyl-N-methylmorpholinium chloride, bromide or monoalkyl sulfate; N—(C₁₂-C₁₈)-alkyl-N-ethylmorpholinium chloride, bromide or monoalkyl sulfate; (C₁₆-C₁₈)-alkylpentaoxethylammonium chloride; diisobutylphenoxyethoxyethyidimethylbenzylammonium chloride; salts of N,N-diethylaminoethylstearylamide and -oleylamide with hydrochloric acid, acetic acid, lactic acid, citric acid, phosphoric acid; N-acylaminoethyl-N,N-diethyl-N-methylammonium chloride, bromide or monoalkyl sulfate and N-acylaminoethyl-N,N-diethyl-N-benzylammonium chloride, bromide or monoalkyl sulfate, where acyl is preferably stearyl or oleyl.

Thickeners employed are xanthan gum and/or cellulose, for example carboxy-, methyl-, ethyl- or propylcellulose in amounts by weight of from 0.01 to 5% based on the finished composition. Suitable solvents are water, ethylene glycol, diethylene glycol and monopropylene glycol.

Suitable dispersants and emulsifiers are amounts of 2 to 30 mol of ethylene oxide and/or 0 to 5 mol of propylene oxide with linear fatty alcohols having 8 to 22 C atoms, with fatty acids having 12 to 22 C atoms and with alkylphenols having 8 to 15 C atoms in the alkyl group; C₁₂-C₁₈-fatty acid monoesters and diesters of adducts of 1 to 30 mol of ethylene oxide with glycerol; glycerol monoesters and diesters and sorbitan monoesters and diesters of saturated and unsaturated fatty acids having 6 to 22 carbon atoms and their ethylene oxide adducts; adducts of 15 to 60 mol of ethylene oxide with castor oil and/or hardened castor oil; polyol and especially polyglycerol esters such as, for example, polyglycerol polyriconoleate and polyglycerol poly-12-hydroxystearate. Likewise suitable are mixtures of compounds of a plurality of these substance classes. The adducts of ethylene oxide and/or propylene oxide with fatty alcohols, fatty acids, alkylphenols, glycerol monoesters and diesters and sorbitan monoesters and diesters of fatty acids or with castor oil are known, commercially available products. They are mixtures homologs whose average degree of alkoxylation corresponds to the ratio of the amounts of ethylene oxide and/or propylene oxide and substrate with which the addition reaction is carried out.

Further adjuvants may be polyglycerol esters, alcohol ethoxylates, alkyl polysaccharides, fatty amine ethoxylates, sorbitan and sorbitol ethoxylate derivatives and derivatives of alk(en)ylsuccinic anhydride. Binders suitable for solid formulations are polyvinylpyrrolidone, polyvinyl alcohol, carboxymethylcellulose, sugars, for example sucrose, sorbitol or starch. Suitable diluents, absorbents or carriers are carbon black, tallow, kaolin, aluminum stearate, calcium stearate or magnesium stearate, sodium tripolyphosphate, sodium tetraborate, sodium sulfate, silicates and sodium benzoate. Cellulose, for example carboxymethylcellulose, polyvinylpyrrolidone, sodium or potassium acetate, carbonates, bicarbonates, sesquicarbonates, ammonium sulfate or potassium hydrogenphosphate act as disintegrants. Alcohol ethoxylates/propoxylates can be used as wetting agents.

In a further preferred embodiment of the invention, the compositions of the invention comprise no further surface-active substances besides the one or more substances of component b). The concept of surface-active substances includes for example surfactants, cosurfactants and emulsifiers.

In a further preferred embodiment of the invention, the compositions of the invention comprise water.

The compositions of the invention are suitable for example in an advantageous manner for weed control. The invention therefore further relates also to the use of a composition of the invention for weed control.

In addition, the compositions of the invention are also advantageously suitable for regulating plant growth. The invention therefore further relates also to the use of a composition of the invention for regulating plant growth.

### EXAMPLES

The invention is illustrated below by means of examples which, however, are by no means to be regarded as restrictive.

Step A: Preparation of the Phosphoric Esters (Adjuvant I, III and V)

Isotridecyl alcohol polyglycol ether is introduced into a four-neck round-bottomed flask and reacted by slowly adding 71 g of phosphorus pentoxide at a suitable reaction temperature. The various isotridecyl alcohol polyglycol ethers are in this case employed in the amounts specified in Table 1.

TABLE 1
Amount of isotridecyl alcohol polyglycol ether

| | Ethylene oxide units per isotridecyl | |
|---|---|---|
| Adjuvant | alcohol polyglycol ether | Amount [g] |
| I | 5 | 420 |
| III | 6 | 464 |
| V | 10 | 640 |

The reaction mixture is then hydrolyzed with 9 g of deionized water (DI water).

Step B: Preparation of Neutralized Phosphoric Esters (Adjuvant II and IV)

500 g of phosphoric ester from step A, 105 g of solubilizer (propylene glycol) and 50 g of DI water are weighed into a four-neck flask equipped with thermometer and reflux condenser. Then, at 50-60° C., 120 g of a 50% by weight solution of potassium hydroxide in water or 85.6 g of a 50% by weight solution of sodium hydroxide in water are slowly added by means of a dropping funnel. The final product which results is a product according to formula (Ia) and Table 2.

TABLE 2

| | |
|---|---|
| | (Ia) |
| 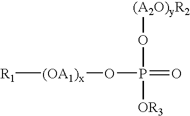 | |

Adjuvant I to V

| Adjuvant | R₁ | A₁ and A₂ | x | y and R₂ | R₃ |
|---|---|---|---|---|---|
| I | i-C₁₃-alkyl | —CH₂CH₂— | 5 | y = 0; R₂ = H (40%) | H |
| | | | | y = 5; | |
| | | | | R₂ = i-C₁₃-alkyl (60%) | |
| II | i-C₁₃-alkyl | —CH₂CH₂— | 5 | y = 0; R₂ = Na (40%) | Na |
| | | | | y = 5; | |
| | | | | R₂ = i-C₁₃-alkyl (60%) | |
| III | i-C₁₃-alkyl | —CH₂CH₂— | 6 | y = 0; R₂ = H (40%) | H |
| | | | | y = 6; | |
| | | | | R₂ = i-C₁₃-alkyl (60%) | |
| IV | i-C₁₃-alkyl | —CH₂CH₂— | 6 | y = 0; R₂ = K (40%) | K |
| | | | | y = 6; | |
| | | | | R₂ = i-C₁₃-alkyl (60%) | |
| V | i-C₁₃-alkyl | —CH₂CH₂— | 10 | y = 0; R₂ = H (40%) | H |
| | | | | y = 10; | |
| | | | | R₂ = i-C₁₃-alkyl (60%) | |

Efficacy of Adjuvants I to V with Clodinafop Propargyl

Test formulations are prepared by mixing the commercially available formulation Topic 240, which contains 240 g of clodinafop propargyl per liter of formulation, as stated by the manufacturer (Syngenta), with water. The adjuvants are added to this emulsion in an amount corresponding to a concentration of 0.25% w/v (2.5 g/l). These test solutions are applied in various concentrations (concentration stated in g a.i/ha, where a.i. means active ingredient) to the plant species Avena fatura L. (AVEFA) while they are in the 2-3-leaf stage in a glasshouse as shown in the following table.

After 21 days, the efficacy of the herbicidal formulation is assessed by weighing the plant parts which are still present (fresh weight). The results are shown in Table 3.

TABLE 3
Effect of phosphated isotridecyl alkoxylate
on the efficacy of clodinafop propargyl

| Clodinafop propargyl | | fresh weight [g] |
|---|---|---|
| [g a.i./ha] | Adjuvant | AVEFA |
| — | — | 17.48 |
| 5 | — | 15.69 |
| 5 | I | 1.54 |
| 5 | II | 1.70 |
| 5 | III | 1.60 |
| 5 | IV | 2.30 |
| 5 | V | 4.25 |

Efficacy of Adjuvants I to V with Imazethapyrammonium

Test formulations are prepared by adjusting an aqueous solution of imazethapyrammonium to a concentration of 5 mmol. The adjuvants are added to this solution in an amount corresponding to a concentration of 0.25% w/v (2.5 g/l). These test solutions are applied in various concentrations (concentration stated g ae/ha, where ae means acidic equivalent) to the plant species Solanum Nigrum L. (SOLNI) and Lolium perenne L. (LOLPE) while they are in the 2-3-leaf stage in a glasshouse as shown in the following table.

After 14 days, the efficacy of the herbicidal formulation is assessed by weighing the plant parts still present (fresh weight). The results are shown in Table 4.

TABLE 4
Effect of phosphated isotridecyl alkoxylate
on the efficacy of imazethapyrammonium

| | |
|---|---|
| Imazethapyrammonium | fresh weight [g] |

| [g ae/ha] | Adjuvant | SOLNI | LOLPE |
|---|---|---|---|
| — | — | 15.42 | 13.97 |
| 4.0 | — | 10.61 | 13.40 |
| 4.0 | I | 2.44 | 5.69 |
| 4.0 | II | 2.34 | 8.70 |
| 4.0 | III | 2.04 | 8.59 |
| 4.0 | IV | 3.05 | 9.65 |
| 4.0 | V | 6.23 | 10.45 |

1. A composition comprising
a) at least one substance selected from the group consisting of: a pesticide, a phytohormone and a mixture thereof, and
b) at least one substance selected from the group consisting of: an alkyl phosphoric ester, an alkylaryl phosphoric ester, and a mixture thereof,
wherein the at least one substance of component b) comprises at least one branched alkyl group.

2. The composition as claimed in claim 1, wherein all the alkyl groups present in the at least one substance of component b) are branched.

3. The composition as claimed in claim 1, wherein the number of carbon atoms in all the alkyl groups of the at least one substance of component b) totals from 6 to 36.

4. The composition as claimed in claim 1, wherein the at least one substance of component b) is of the formula (I) 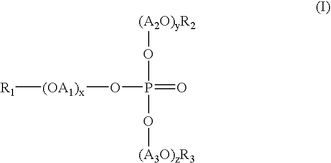
wherein
R₁ is a branched, saturated or unsaturated alkyl or alkenyl radical having 6 to 30 carbon atoms, or an aryl group.
R₂ and R₃ are each independently of one another hydrogen, alkali metal, alkaline earth metal, substituted or unsubstituted ammonium or organic basic groups or R₁,
A₁, A₂ and A₃ are each independently of one another an alkylene group having 2 to 4 carbon atoms, and
x, y and z are each independently of one another a number from 0 to 30.

5. The composition as claimed in claim 1, wherein the at least one substance of component b) is an isotridecyl phosphoric ester or a salt thereof.

6. The composition as claimed in claim 5, wherein the isotridecyl phosphoric ester comprises 0 to 30 ethylene oxide units.

7. The composition as claimed in claim 1, wherein the at least one substance of component b) is a mixture of isotridecyl phosphoric esters in which the proportion of monoester is from 40 to 60% by weight and the proportion of diester is from 40 to 60% by weight.

8. The composition as claimed in claim 1, wherein the at least one substance of component b) is a tri-sec-butylphenol phosphoric ester or a salt thereof.

9. The composition as claimed in claim 8, wherein the tri-sec-butylphenol phosphoric ester comprises 4 to 8 ethylene oxide units.

10. The composition as claimed in claim 1, wherein the at least one substance of component b) is a mixture of tri-sec-butylphenol phosphoric esters in which the proportion of monoester is from 40 to 60% by weight and the proportion of diester is from 40 to 60% by weight.

11. The composition as claimed in claim 1, wherein the at least one substance component a) is a pesticide.

12. The composition as claimed in claim 1, wherein the at least one substance of component a) is a herbicide.

13. The composition as claimed in claim 1, wherein the at least one substance of component a) is clodinafop propargyl or imazethapyr-ammonium.

14. The composition as claimed in claim 1, wherein the composition is a solid preparation and comprises the at least one substance component a) in an amount from 20 to 80% by weight and the at least one substance of component b) in an amount amounts of from 5 to 60% by weight.

15. The composition as claimed in claim 1, wherein the composition is a liquid concentrate formulation and comprises the at least one substance of component a) in an amount of from 5 to 50% by weight and the at least one substance of component b) in an amount of from 5 to 70% by weight.

16. The composition as claimed in claim 1, wherein in addition to the at least one substance of component b), comprises no further surface-active substances.

17. The composition as claimed in claim 1 further comprising water.

18. A process for weed control comprising the step of contacting a weed with the composition according to claim 1.

19. A process for regulating plant growth comprising the step of contacting a plant with the composition according to claim 1.

20. The composition as claimed in claim 1, wherein the number of carbon atoms in all the alkyl groups of the at least one substance of component b) totals from 6 to 30.

21. The composition as claimed in claim 1, wherein the number of carbon atoms in all the alkyl groups of the at least one substance of component b) totals from 8 to 22.

22. The composition as claimed in claim 4, wherein R₁ is a branched, saturated or unsaturated alkyl or alkenyl radical having 8 to 22 carbon atoms.

22. The composition as claimed in claim 4, wherein R₁ is a branched, saturated or unsaturated alkyl or alkenyl radical having 12 to 18 carbon atoms.

23. The composition as claimed in claim 4, wherein R₁ is a phenyl group, substituted by 1 to 3 branched alkyl groups, wherein the 1 to 3 branched alkyl groups each comprise independently of one another 3 to 18 carbon atoms.

23. The composition as claimed in claim 4, wherein R₁ is a phenyl group, substituted by 1 to 3 branched alkyl groups, wherein the 1 to 3 branched alkyl groups each comprise independently of one another 4 to 12 carbon atoms.

24. The composition as claimed in claim 4, wherein x, y and z are each independently of one another a number from 1 to 20.

25. The composition as claimed in claim 4, wherein x, y and z are each independently of one another a number from 4 to 10.

26. The composition as claimed in claim 4, wherein x, y and z are each independently of one another a number from 6 to 8.

27. The composition as claimed in claim 5, wherein the isotridecyl phosphoric ester comprises 1 to 20 ethylene oxide units.

28. The composition as claimed in claim 5, wherein the isotridecyl phosphoric ester comprises 2 to 10 ethylene oxide units.

29. The composition as claimed in claim 1, wherein the at least one substance of component a) is selected from the group consisting of: a herbicide, an insecticide, a fungicide, an acaricide, a bactericide, a molluscide, a nematocide and a rodenticide.

30. The composition as claimed in claim 1, wherein the at least one substance of component a) is selected from the group consisting of: acetochlor, acifluorfen, aclonifen, acrolein, alachlor, ametryn, amitrol, asulam, atrazine, benazolin, bensulfuron-methyl, bentazone, benzofenap, bialaphos, bifenox, bilanafos, bromacil, bromobutide, bromofenoxim, bromoxynil, butachlor, butafenacil, chlormethoxyfen, chloramben, chloracetic acid, chlorbromuron, chlorimuron-ethyl, chlorotoluron, chlornitrofen, chlorotoluron, chlorthal-dimethyl, clodinafop, clodinafop propargyl, clopyralid, clomeprop, cyanazine, 2,4-D, 2,4-DB, diamuron, dalapon, desmedipham, desmetryn, dicamba, dichlorbenil, dichlorprop, diclofop, difenzoquat, diflufenican, dimefuron, dimethachlor, dimethametryn, dimethenamid, dinitramine, diquat, diuron, endothall, ethametsulfuron-methyl, fenac, fenclorim, fenoxaprop, fenoxaprop-ethyl, flamprop, fenoxaprop-methyl, flazasulfuron, fluazifop, fluazifop-p-butyl, flumetsulam, flumiclorac, flumiclorac-phenyl, fluoroglycofen, flumetsulam, flumeturon, flumioxazin, flupoxam, flupropanate, fluridon, flurtamon, fomesafen, fosamine, glufosinate, glyphosate, haloxyfop, imazapic, imazameth, imazamethabenz, imazamox, imazapic, imazapyr, imazaquin, imazethapyr, imazethapyr-ammonium, ioxynil, isoproturon, isoxaben, isoxapyrifop, lactofen, lenacil, linuron, MCPA, MCPB, mecoprop, mefenacet, mesotrion, metazachlor, methabenzthiazuron, methylarsonic acid, metachlor, metobenzuron, naproanilide, naptalam, neburon, nonanoic acid, norflurazon, oryzalin, oxadiazon, oxyfluorfen, paraquat, phenmedipham, picloram, pretilachlor, prodiamine, prometon, prometryn, propachlor, propazine, propisochlor, propyzamide, pyrazolynate, pyrazosulfuron-ethyl, pyributicarb, pyridate, quinclorac, quizalofop, quizalofop-ethyl, rimsulfuron, siduron, simazine, simetryn, sulfamic acid, 2,3,6-TBA, TCA, terbumeton, terbuthylazine terbutyrin, trichloroacetic acid, triclopyr, trietazine, thenylchlor, thiazopyr, trialkoxydim, trietazine and their salts.
